(19) United States
(12) Patent Application Publication
(10) Pub. No.: US 2025/0348422 A1
(43) Pub. Date: Nov. 13, 2025

(54) SYNCHRONIZATION TECHNIQUES BETWEEN SINGLE-SITE AND MULTI-SITE DUT TEST PROGRAMS

(71) Applicant: Advantest Corporation, Tokyo (JP)

(72) Inventor: Huachun CUI, San Jose, CA (US)

(21) Appl. No.: 18/809,661

(22) Filed: Aug. 20, 2024

Related U.S. Application Data
(60) Provisional application No. 63/643,824, filed on May 7, 2024.

(51) Int. Cl. G06F 11/36

(52) U.S. Cl. CPC G06F 11/3698

(57) ABSTRACT

A method of testing a plurality of DUTs in a test system. The method includes generating a plurality of instances of a single-site test program causing test system hardware to test the DUTs, wherein each instance is associated with a respective DUT and operates on a respective single-site test system. The method also includes analyzing the plurality of instances to determine first code segments contain a conditional statement and second code segments free of any conditional statements. The method further includes receiving, at said test system, requests to execute code segments from the plurality of instances and executing the received requested code segments by causing the test system hardware to apply tests to the DUTs based thereon. The first code segments are executed as they are requested, and requested second code segments of a same code identifier are synchronized for parallel execution.

### CROSS-REFERENCE TO RELATED APPLICATIONS

This application claims the benefit of U.S. Provisional Patent Application No. 63/643,824 filed May 7, 2024, which is incorporated herein in its entirety.

### BACKGROUND OF THE INVENTION

Products, including but not limited to electronic devices, are commonly developed in a research and development department of a company. Thereafter the product is manufactured by a production department of the company for large scale manufacturing of the device. During research and development, products under development typically require various tests to detect and fix errors and defects, verify designs, evaluate performance parameters, evaluate design alternatives, optimize designs and the like. In research and development, such tests are typically performed on a limited number of units on an individual basis or a few units sequentially. Tests are commonly performed utilizing various test equipment such as multimeters, logic analyzers and the like under the control of software. For example, as illustrated in FIG. 1, a device under test (DUT) 110 can be coupled to a single-site test controller 120 and one or more test instruments 130 of a test system 100 by one or more communication interfaces such as but not limited to a peripheral component interface express (PCIe) interface 140, an ethernet interface 150, and one or more radio frequency (RF) pins 160. The single-site test controller 120 can include hardware and software to control testing of the device under test (DUT) 110, and test measurements by the one or more test instruments 130. Test software in research and development is commonly written in a script language such as the Python programming language for instance and is designed to test a single DUT.

In production, the product is typically tested by automated test equipment configured to test a plurality of units in parallel to achieve high product testing throughput. The tests are typically managed by software to verify the operation of the units, characterize performance parameters and the like. The software for testing multiple devices in parallel is commonly a production test program, such as SmarTest8 with Java and other domain specific language (DSL) files for instance. Production test programs, such as SmarTest8, may restrict measurement to be done serially. Different tests sites under control of a production test program, such as SmarTest8, cannot execute different measurements at the same time. Only when execution of test functions at multiple sites are aligned to do the same measurements, is the cost effectiveness of production test programs such as SmarTest8 improved.

There are tests developed in the low volume development test routines that can also be utilized in production test routines. However, the software written for testing individual units, or a small number of units sequentially, is not readily adaptable to testing multiple units in parallel in high throughput testing. The script language-based development test routine can be totally rewritten in a multi-site test program, such as SmarTest8, for production testing of devices. Alternatively, the script language-based test routines can be kept unchanged as much as possible, and a bridging solution can enable them to cooperate with a multi-site test program such as SmarTest8.

By totally rewriting a test routine, from a script language to a SmarTest8 test program for example, production testing can achieve relatively high performance. However, the development time for converting from the script language to SmarTest8 is relatively long, and consumes a relatively large amount of development resources. Further, the correlation between the development test program and the production test program is relatively difficult and costly. In addition, the synchronization of changes in the development test program to the production SmarTest8 test program is relatively loose.

Alternatively, keeping script language tests relatively unchanged and utilizing a bridge solution provides for a relatively short development time and consumes a relatively small amount of development resources. Further, the synchronization of changes in the development test program to the production SmarTest8 program is relatively easy. However, testing performance is not as fast, because of the communication overhead between the development test program and the production test program.

Accordingly, there is a continuing need for improved techniques for converting bench tests for testing single or relatively small numbers of units to production test systems for testing a large number of units in parallel.

### SUMMARY OF THE INVENTION

The present technology may best be understood by referring to the following description and accompanying drawings that are used to illustrate embodiments of the present technology directed toward pace synchronization between a multi-site DUT test program and multiple heterogeneous single-site DUT test programs.

In one embodiment, a test environment includes a plurality of devices under test (DUTs) and a multi-site test system including test system hardware. A method of testing thereon includes generating a plurality of instances of a test program within a plurality of single-site testers, the plurality of instances causing the test system hardware to test a plurality of DUTs, wherein each instance is associated with a respective single-site tester and associated with a respective DUTs. The method further includes analyzing the plurality of instances to determine first code segments that comprise one of: a loop of a conditional loop count and an IF statement, and to determine second code segments that are free of a loop of a conditional count and an IF statement. The method also includes receiving, at the multi-site test system, requests to execute code segments from the plurality of instances and executing received requested code segments by applying tests to the plurality of DUTs based thereon. The executing includes delaying execution of one or more requested second code segments of a same code identifier until all of the plurality of instances have requested execution of the second code segments of the same code identifier; and subsequent to the delaying, executing the requested second segments of the same code identifier on all of the plurality of DUTs in parallel.

In yet another embodiment, a method of testing in a test environment comprising a plurality of single-site test systems each operable to run a single-site test program for a respective single device under test (DUT) and a multi-site test system including test system hardware configured for generating a plurality of instances of the single-site test program for the plurality of single-site test systems for testing a plurality of DUTs, wherein each single-site test system receives a respective instance of the plurality of instances. The test method also includes analyzing the plurality of instances to determine first code segments that comprise conditional statements and second code segments that are free of conditional statements. The test method further includes receiving requests, at the multi-site test system, to execute code segments from the plurality of instances and the multi-site test system executing received requested code segments by causing the test system hardware to apply tests to the plurality of DUTs based thereon. Executing the code segments includes delaying execution of one or more requested second code segments of a same code identifier until all of the plurality of instances have requested execution of the second code segments of the same code identifier. Executing the code segments further includes executing the requested second segments of the same code identifier on all of said plurality of DUTs in parallel, wherein all of the plurality of instances have requested execution of the second code segments of the same code identifier.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF DRAWINGS

Embodiments of the present technology are illustrated by way of example and not by way of limitation, in the figures of the accompanying drawings and in which like reference numerals refer to similar elements and in which:

FIG. 1 shows a single-site test system in accordance to the conventional art.

FIG. 2 shows a multi-site test system, in accordance with aspects of the present technology.

FIG. 3 shows a conversion technique for converting a single-site DUT test program to a multi-site DUT test program, in accordance with aspects of the present technology.

FIG. 4 shows cooperation between an exemplary Java test system code and an example Python single-site test code, in accordance with aspects of the present technology.

FIG. 5 shows a method of converting a single-site DUT test program to a multi-site DUT test program, in accordance with aspects of the present technology.

FIG. 6 shows a plurality of execution trajectories of a single-site DUT test program, in accordance with aspects of the present technology.

FIG. 7 shows a method of determining the longest execution sequence of the DUT test program, in accordance with aspects of the present technology.

FIG. 8 shows the determination of common milestone paces for the plurality of execution trajectories of the DUT test program, in accordance with aspects of the present technology.

FIG. 9 shows the synchronization of common milestone paces of the DUT test program allowing parallel execution thereof, in accordance with aspects of the present technology.

FIG. 10 shows a test environment, in accordance with aspects of the present technology.

FIG. 11 shows a test environment, in accordance with aspects of the present technology.

FIG. 12 shows a centralized multi-site test system according to the conventional art.

FIG. 13 shows a decentralized multi-site test system, in accordance with aspects of the present technology.

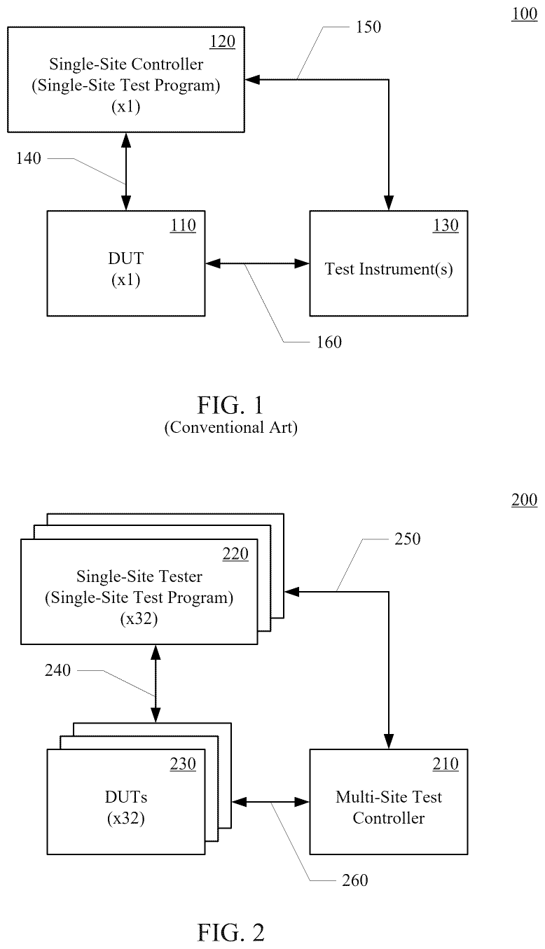

### DETAILED DESCRIPTION OF THE INVENTION

Reference will now be made in detail to the embodiments of the present technology, examples of which are illustrated in the accompanying drawings. While the present technology will be described in conjunction with these embodiments, it will be understood that they are not intended to limit the technology to these embodiments. On the contrary, the invention is intended to cover alternatives, modifications and equivalents, which may be included within the scope of the invention as defined by the appended claims. Furthermore, in the following detailed description of the present technology, numerous specific details are set forth in order to provide a thorough understanding of the present technology. However, it is understood that the present technology may be practiced without these specific details. In other instances, well-known methods, procedures, components, and circuits have not been described in detail as not to unnecessarily obscure aspects of the present technology.

Some embodiments of the present technology which follow are presented in terms of routines, modules, logic blocks, and other symbolic representations of operations on data within one or more electronic devices. The descriptions and representations are the means used by those skilled in the art to most effectively convey the substance of their work to others skilled in the art. A routine, module, logic block and/or the like, is herein, and generally, conceived to be a self-consistent sequence of processes or instructions leading to a desired result. The processes are those including physical manipulations of physical quantities. Usually, though not necessarily, these physical manipulations take the form of electric or magnetic signals capable of being stored, transferred, compared and otherwise manipulated in an electronic device. For reasons of convenience, and with reference to common usage, these signals are referred to as data, bits, values, elements, symbols, characters, terms, numbers, strings, and/or the like with reference to embodiments of the present technology.

It should be borne in mind, however, that these terms are to be interpreted as referencing physical manipulations and quantities and are merely convenient labels and are to be interpreted further in view of terms commonly used in the art. Unless specifically stated otherwise as apparent from the following discussion, it is understood that through discussions of the present technology, discussions utilizing the terms such as “receiving,” and/or the like, refer to the actions and processes of an electronic device such as an electronic computing device that manipulates and transforms data. The data is represented as physical (e.g., electronic) quantities within the electronic device's logic circuits, registers, memories and/or the like, and is transformed into other data similarly represented as physical quantities within the electronic device.

In this application, the use of the disjunctive is intended to include the conjunctive. The use of definite or indefinite articles is not intended to indicate cardinality. In particular, a reference to “the” object or “a” object is intended to denote also one of a possible plurality of such objects. The use of the terms “comprises,” “comprising,” “includes,” “including” and the like specify the presence of stated elements, but do not preclude the presence or addition of one or more other elements and or groups thereof. It is also to be understood that although the terms first, second, etc. may be used herein to describe various elements, such elements should not be limited by these terms. These terms are used herein to distinguish one element from another. For example, a first element could be termed a second element, and similarly a second element could be termed a first element, without departing from the scope of embodiments. It is also to be understood that when an element is referred to as being “coupled” to another element, it may be directly or indirectly connected to the other element, or an intervening element may be present. In contrast, when an element is referred to as being “directly connected” to another element, there are not intervening elements present. It is also to be understood that the term “and or” includes any and all combinations of one or more of the associated elements. It is also to be understood that the phraseology and terminology used herein is for the purpose of description and should not be regarded as limiting.

Referring to FIG. 2, a multi-site test system, in accordance with aspects of the present technology, is shown. The multi-site test system 200 can include a multi-site test controller 210 and a plurality of single-site testers 220. In another implementation, the multi-site test system 200 can include a multi-site test controller 210 and a single-site tester 220, wherein the single-site tester 220 executes multiple instances of a single-site test program. The multi-site test controller 210 and the one or more single-site testers 220 can be coupled to a plurality of devices under test (DUTs) by one or more communication interfaces 240, 250, 260, wherein each single-site tester 220 is coupled to a respective DUT 230. In an exemplary implementation, the multi-site test controller 210 can be coupled to the plurality of single-site testers 220 by an ethernet communication interface, the plurality of single-site testers 220 can be coupled to the plurality of DUTs 230 by peripheral component interface express (PCIe) interfaces, and the multi-site test controller 210 can be coupled to the plurality of DUTs 230 by one or more interfaces including by not limited to RF pins, pogo pins or the like.

The multi-site test system 200 is adapted for configuring the single-site test program, of the conventional art, developed in an engineering, design, research and development (R&D) or the like phase, for operation on the multi-site test controller 210 and the one or more single-site testers 220 for production testing or the like phase. The single-site test program of the single-site controller 120 can be adapted as single-site test program by the plurality of single-site testers 220 controlled by the multi-site test controller 210. Configuring the single-site test program can include analyzing a plurality of instances of execution of the single-site test program to give each call (e.g., call_smt( ) function) from single-site test program to the multi-site test controller 210 a meaningful pace parameter if it can synchronize a given measurement between sites, or leave the pace parameter blank if it cannot help synchronize. The trajectories of the instances of the single-site test program can then be learned to generate quality milestone paces that can optimize synchronization of measurements during future execution of the instances of the single-site test program. In such case, most calls (e.g., call_smt( )) in if-statements or unfixed count loops cannot help synchronization, so pace parameters can be left blank, and most calls not in if-statements or unfixed count loops may have a meaningful pace parameter.

The one or more single-site testers 220 perform instances of a test program to test the DUTs 230. Each instance of the test program is associated with a respective DUT of the plurality of DUTs 230. The multi-site test controller 210 can control the plurality of instances of the single-site test program on the one or more single-site testers 220. The code segments of the single-site test program on respective single-site testers 220 apply test to respective DUTs, wherein execution measurements during one or more code segments free of loop of conditional loop count and IF statements are synchronized such that all of a plurality of execution instances of the single-site test program request execution of the given code segments free of loop of conditional loop count and IF statements having a same code identifier.

After synchronizing execution of measurements, the given code segments free of loop of conditional loop count and IF statements having same code identifiers can be executed on all of the plurality of DUTs 210 in parallel. The code segments including loop of conditional loop count and IF statements of differing code identifiers can be executed when requested. Further, the code segments including loop of conditional loop count and IF statements of the same code identifiers can advantageously be synchronized to align given measurement operations on the plurality of DUTs. The combination of executing the code segments free of loop of conditional loop count and IF statements having a same code identifier, and then executing the code segments free of loop of conditional loop count and IF statements having the same code identifier in parallel operates to synchronize execution of code segments free of loop of conditional loop count and IF statements. Accordingly, the overall time for testing a plurality of DUTs is reduced by aligning given measurements on the plurality of DUTs.

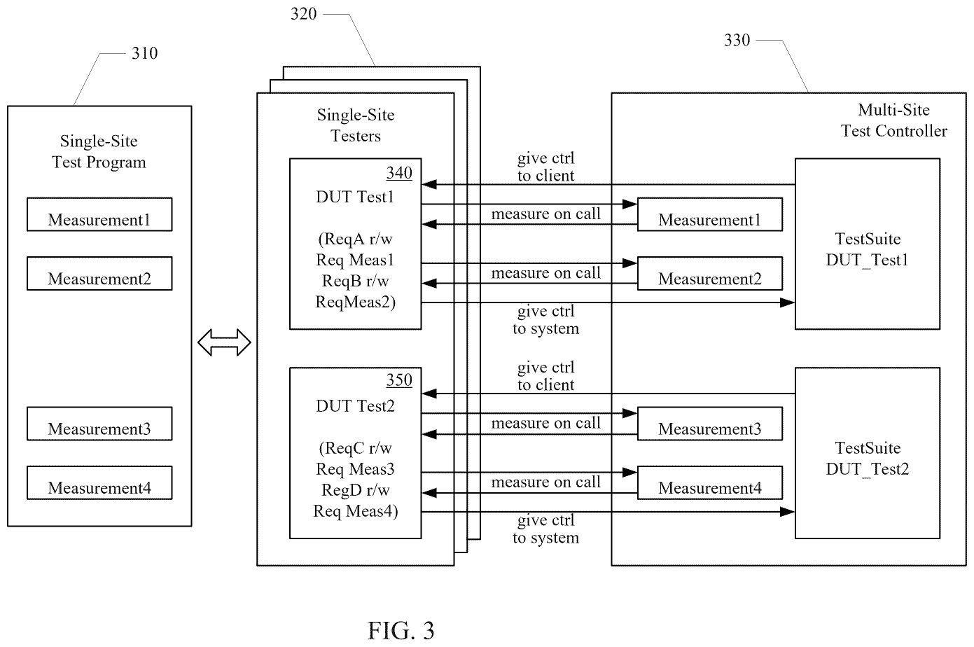

Referring to FIG. 3, a technique for converting a single-site device under test (DUT) test program to a multi-site DUT test program 300, in accordance with aspects of the present technology, is shown. The single-site DUT test program 310 can be a script language-based test program for testing DUTs. The script language-based test program 310 can be written for single-site testing of individual DUTs in a research and development (R&D) environment. The script language-based test program can be, but is not limited to, a Python programming language test program. The single-site test program 310 can be converted to a single-site tester 320 and a multi-site test controller 330, wherein the multi-site test controller 320 is configured to control a plurality of instances of the single site tester 320 to test a plurality of DUTs. The single-site tester 320 can include a number of tests that include reading or writing (rw) measurements to or from given register.

For example, a first DUT test 340 can include requesting a first measurement (Req Meas 1) that includes reading or writing (r/w) a value to a first register (Reg1), and requesting a second measurement (Req Meas 2) that includes reading or writing (r/w) a value to a second register (Reg2). Likewise, a second DUT test 350 can include requesting a third measurement (Req Meas 3) that includes reading or writing (r/w) a value to a third register (Reg3), and requesting a fourth measurement (Req Meas 4) that includes reading or writing (r/w) a value to a fourth register (Reg4). The multi-site test controller 330 can start by giving control to the plurality of instances of the single-site testers 320, and controlling measurements with calls to corresponding measurements that includes synchronizing measurements for pace synchronization. The tests can conclude with passing control from the single-site DUT testers 320 back to the multi-site DUT test controller 330.

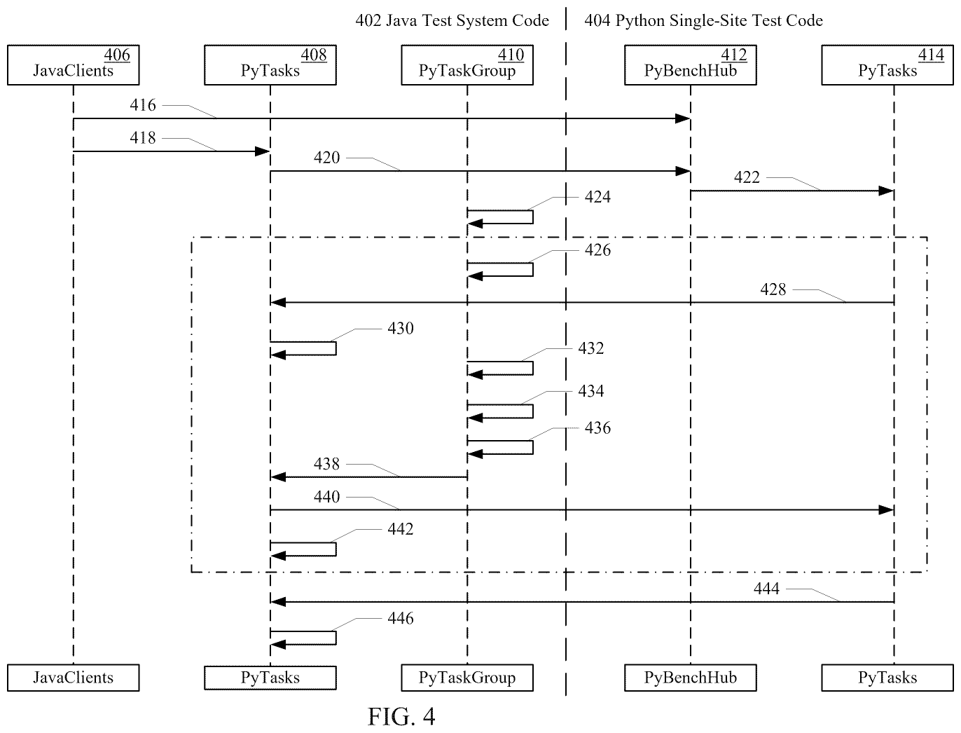

Referring now to FIG. 4, cooperation between an exemplary Java test system code and an example Python single-site test code, in accordance with aspects of the present technology, is shown. Cooperation between the Jave test system code 402 and the Python single-site test code 404 begins with connecting/reconnecting 416 between Java clients 406 of the Java test system code 402 and a Python bench hub 412 of the Python single-site test code 404. Python task objects 418 are created between the Java clients 406 and Python tasks 414 of the Java test system code 402. Tasks 420 are created between the Python tasks 408 of the Java test system code 402 and the Python bench hub 412 of the Python single site test code 404. Task objects 422 are created between the Python bench hub 412 and Python tasks 414 of the Python single-site test code 404. Python tasks groups with Python tasks 424 are created for the Python task group 410 of the Java test system code 402.

Thereafter, the Python tasks group 410 of the Java test system code 402 waits for the pace of all tasks 426. A routing having pace and measurement command as parameters is called 428 between the Python tasks 414 of the Python single-site test code 404 and the Python tasks 408 of the Java test system code 402. The Python tasks 408 of the Java test system code 402 enters waiting mode 430, and the Python task group 410 of the Java test system code 402 obtains a summary 432, gets the slowest tasks 434 and does measurements 436. The Python task group 410 of the Java test system code 402 responds to the python tasks 408 with the Python result 438. The Python tasks 408 of the Java test system code 402 sends results of the call to the Python tasks 414 of the Python single-site test code 404. The Python tasks 408 of the Java test system code 402 enters running mode 442, wherein the processes of 426-442 are performed in a loop while any tasks are still alive. The Python tasks 414 of the Python single-site test code 404 indicates execution is finished 444 to the Python tasks 408 of the Java test system code 402 after the loop of 426-442 is exited. The Python tasks 408 of the Java test system code 402 thereafter enters the done mode 446.

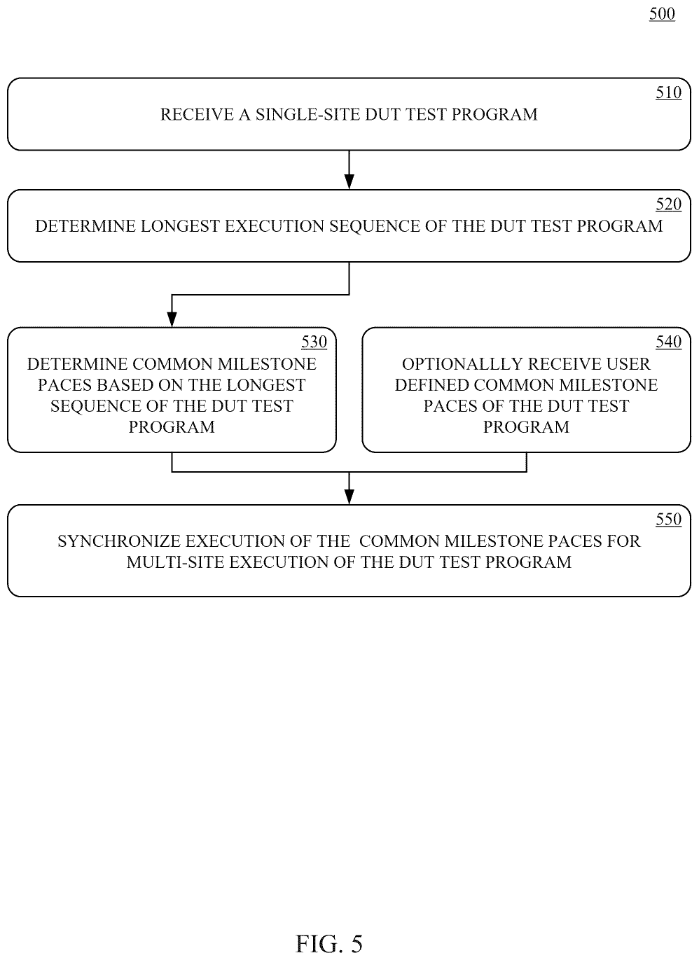

Referring now to FIG. 5, a computer implemented method of converting a single-site DUT test program to a multi-site DUT test program 500, in accordance with aspects of the present technology, is shown. The method includes receiving a single-site DUT test program, at 510. In one implementation, the single-site DUT test program can be written in a script based-language, such as but not limited to, a single-site DUT test program written in the Python programming language. At 520, a longest execution sequence of the DUT test program is determined. In one implementation, the function of the single-site DUT test program can be to test DUTs at a plurality of sites. Execution of single-site DUT test can be looped while testing DUTs to check the execution trajectory of the single-site DUT test program. For example, the single-site DUT test can be executed on a plurality of DUTs at a plurality of different DUTs test sites, and the execution sequence of the single-site DUT test testing the plurality of DUTs can be logged.

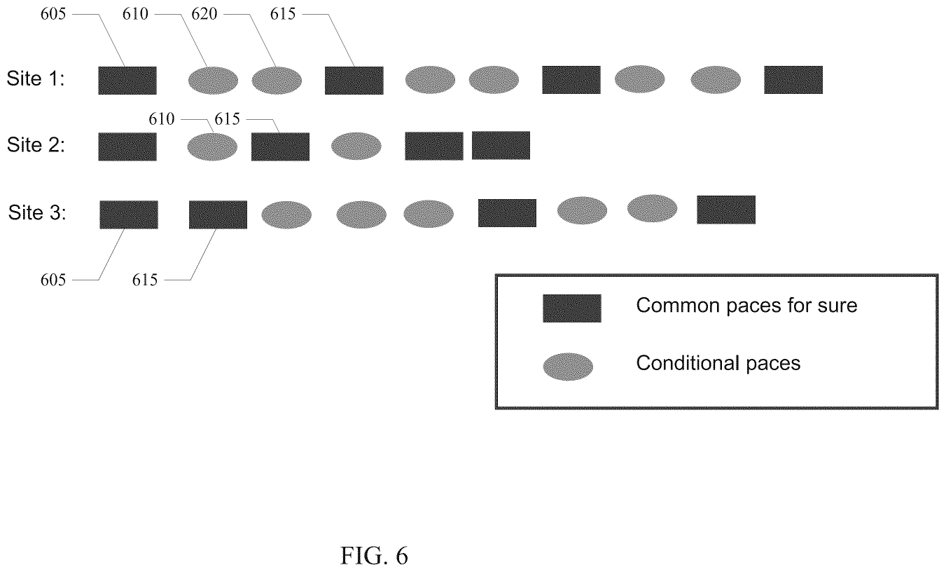

Referring now to FIG. 6, a plurality of execution trajectories of a single-site DUT test program 600 are illustrated. The rectangles in FIG. 6 (e.g., 605, 615) represent code sections that perform measurements and include a conditional statement or loop statement, while the ovals (e.g., 610, 620) represent code sections that perform measurements but do not include a conditional statement or loop statement. The rectangle code sections (e.g., 605, 615) including a conditional statement or loop statement cause the conditional execution of one or more oval code sections (e.g., 610, 620) and/or repeated instances of the oval code sections (e.g., 610, 620). Therefore, the rectangle code sections (e.g., 605, 615) can be considered common paces, and the oval code sections (e.g., 610, 620) can be considered conditional paces. The execution of the same single-site DUT test program can generate different execution trajectories for different DUT units because of ‘if statements,’ ‘conditional loop statement’ or the like of the DUT test program. For example, for each of a plurality of units, the test program starts with execution of the same first portion of code 605. An ‘if statement’ or ‘conditional loop statement’ in the first portion 605 of code may then cause any of a number of different portions of code 610, 615 of the test program to be executed for different units of the DUTs. At various points during the execution of the test program all of the units of the DUTs may execute another same portion 615 of the test program. Again, another ‘if statement’ or ‘conditional loop state’ in the other same portion 615 of the test program executed by each of the units of the DUTs may cause any number of other portions of the code of the test program to be executed by different units, or a given portion to be executed a different number of times for different DUTs. Therefore, different units of the DUTs will execute different trajectories of the test program code. The test program can be repeatedly executed on a plurality of DUTs to determine the longest common sequence.

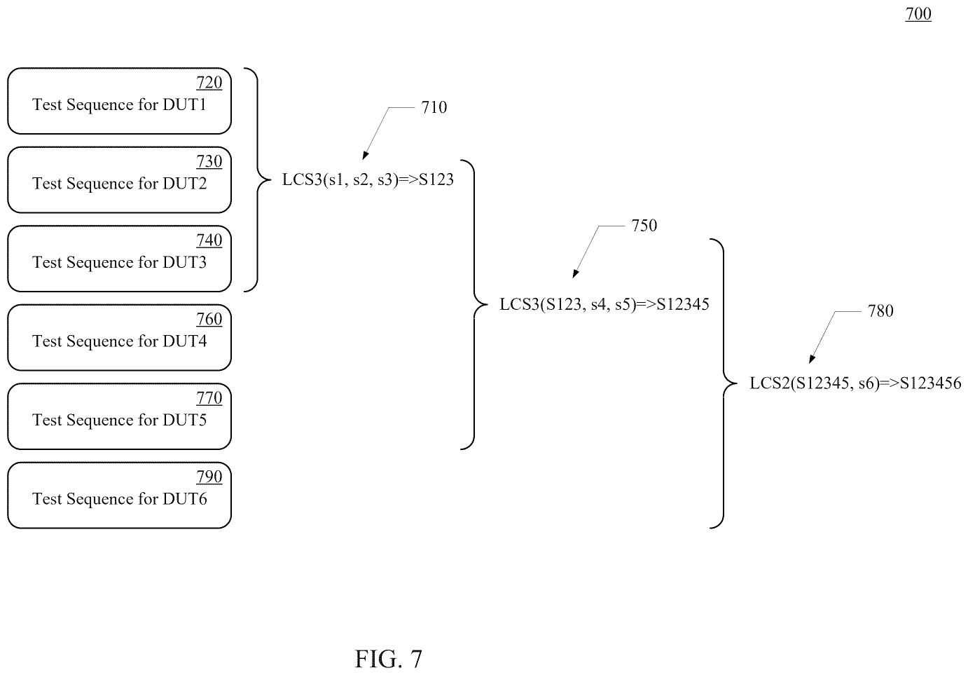

Referring now to FIG. 7, a method of determining the longest execution sequence of the DUT test program, in accordance with aspects of the present technology. The method 700 can include determining a longest common subsequence (LCS) common to the sequences of code execution in sets of two or more sequences. For example, a first LCS 710, LCS3(s1, s2, s3)=>S123, can be calculated for the sequence execution of the DUT test program 720, 730, 740 on a first, second and third DUT in a first iteration. A second LCS 750, LCS3(S123, s4, s5)=>S12345, can be calculated for the combination of the first LCS 710 and the execution of the DUT test program on a fourth and fifth DUT 760, 770 in second iteration. A third LCS 780, LCS2(S12345, cs6)=>S123456, indicating the longest execution sequence of the DUT test program can be calculated from the combination of the second LCS 750 and the execution of the DUT test program on a sixth DUT 790 in a third iteration.

Referring again to FIG. 5, milestone paces are determined or estimated based on the determined longest common sequences of the DUT test program, at 530. Milestone paces can be determined based on longest common sequence having an IF statement, a conditional loop statement or the like therein.

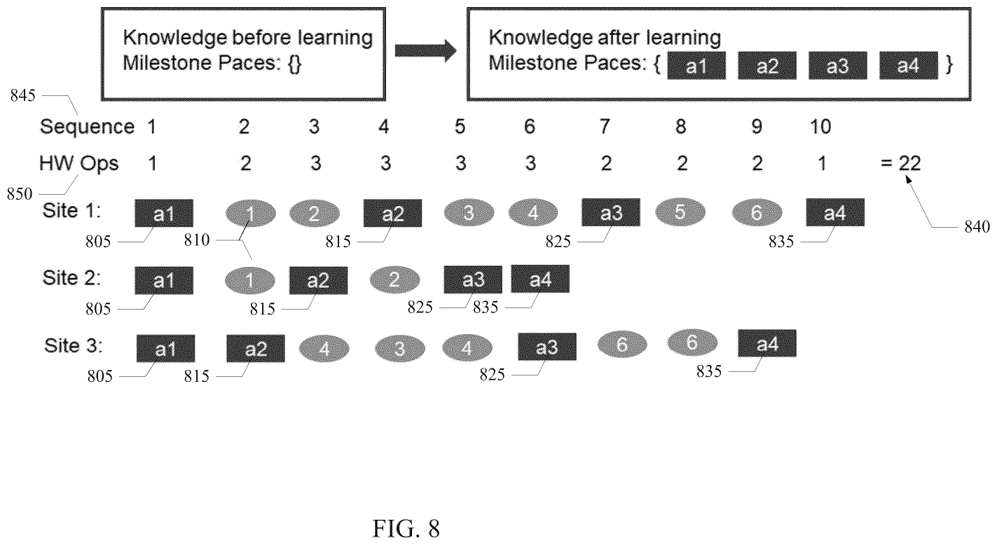

Referring now to FIG. 8, determination of common milestone paces for the plurality of execution trajectories of the DUT test program 800 is illustrated. Again, the execution of the same single-site DUT test program can generate different execution trajectories for different units of DUTs because of ‘if statements,’ ‘conditional loop statement’ or the like of the DUT test program. For example, for each of a plurality of units, the test program starts with execution of the same first portion of code. An ‘if statement’ or ‘conditional loop statement’ in the first portion of code may then cause any of a number of different portions of code of the test program to be executed for different units of the DUTs. At various points during the execution of the test program all of the units of the DUTs may execute another same portion of the test program. Again, another ‘if statement’ or ‘conditional loop state’ in the other same portion of the test program executed by each of the units of the DUTs may cause any number of other portions of the code of the test program to be executed by different units. For example, each unit of the DUTs may execute a first portion of code. At various later times during the execution of the test program, all of the units may execute another same portion of code. At yet other various later times, all of the units may execute yet another same portion of the code, and so on. The portions of code of the test program that are executed by all of the DUTs at various times in a given sequence are determined to be common milestone paces 805, 815, 825, 835, which include IF statements, conditional loop statements or the like. The code sections that perform measurements and include an IF statement, conditional loop statement or the like can be executed in parallel when delayed or synchronized as further described below.

In a multi-site test program, such as SmarTest8, a given measurement performed by a given portion of code must be done at the same time on the plurality of sites. Therefore, if different tests 810, 815 are to be performed on different sites, the tests need to be performed sequentially. In the conventional process, execution of the test program may for example consume one hardware operation to execute the first common milestone pace 805 at the same time on all three sites, then two hardware operations are consumed to first perform a measurement of a second portion of code 810 at the first and second site and then a different measurement of a second common milestone pace 815 at the third site, and so on. In the illustrated example, the conventional technique would consume twenty two (22) 850 hardware operation cycles (HW Ops) 840 to perform the different trajectories of the test program at the three different test sites. For example, at a first portion of execution 845, code section a1 805 can be performed together in one (1) HW Op cycle 850. At a second portion, execution of code section 1 810 at sites 1 and 2 can be performed together, and then the code section a2 815 at site 3 can be performed, which therefore requires 2 HW Op cycles 850. At a third portion of execution 845, execution of code sections 2, a2 and 4 need to be performed sequentially, which therefore requires three (3) HW Op cycles 850. Measurements for different code sections at a plurality of sites need to be performed sequentially because only one hardware unit is provided for all of the DUTs for the multi-site test program such as SmarTest8.

Referring again to FIG. 5, the processes at 520 and 530 can be repeated on a number of DUTs at a plurality of test sites in a learning phase to determine the longest execution sequence of the DUT test program and to determine common milestone paces. Furthermore, user defined common milestone paces can also be received, at 540. Identification of common milestone paces can be received from a user. At 550, execution of the common milestone paces are synchronized for multi-site execution of the DUT test program by delaying execution of earlier registered milestones until all are registered.

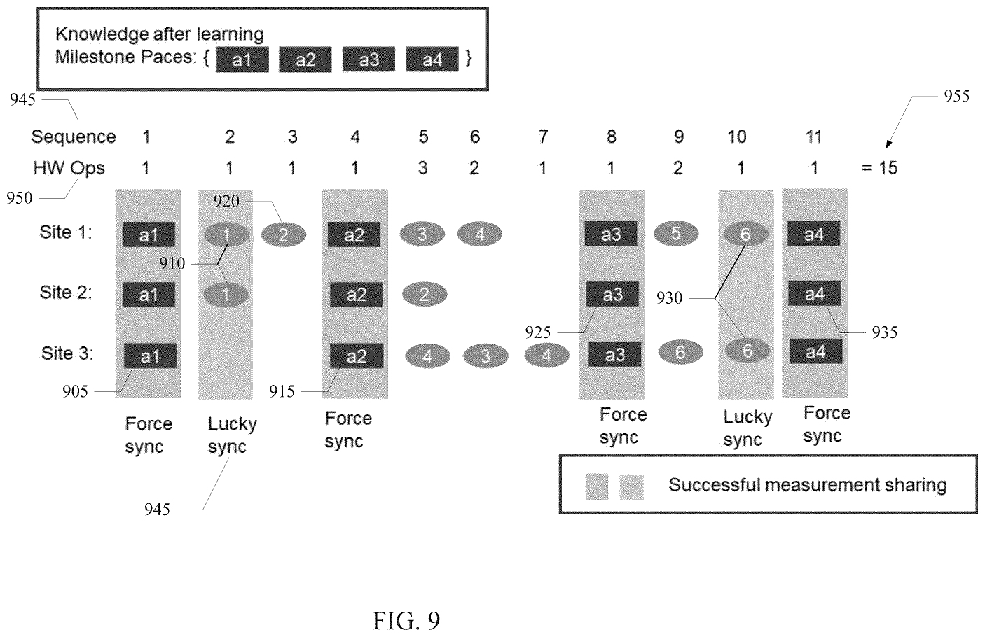

Referring now to FIG. 9, the synchronization of common milestone paces of the DUT test program 900 is illustrated. The test program is executed on a plurality of DUTs. At a first portion of execution 945, code section a1 905 can be performed together in one (1) HW Op Cycle 950. At a second portion, execution of code section 1910 at sites 1 and 2 can be performed together, which requires one (1) HW Op cycle 950. Code section 1910 at sites 1 and 2 happen to occur at both sites 1 and 2 at the same time without any active (e.g., forced) synchronization, and therefore can be considered to be a lucky synchronization because they happen to be execution together in one (1) HW op 950. Measurements in non-common code sections can be referred to as lucky synchronization occurrences 945, because the given code segment 910 occur at two or more of the sites at the same time without the need to delay execution to get them to occur at the same time and there are no other measurement to be made at other sites at the given time. When a common milestone pace a2 915 is reached at the site 3, execution of the test program by the respective DUT is paused or delayed until execution of the given common milestone pace 915 is reached at sites 1 and 2. In a third portion of execution 945, code section 2 920 can be performed, which requires one (1) HW Op cycle 950. At a fourth portion of execution 945, code section a2 915 at sites 1-3 can be performed together, which requires one (1) HW Op cycle 950. At a fifth portion of execution 945, code sections 3, 2 and 4 are executed sequentially at sites 1, 2 and 3 respectively, which requires three (3) HW Op cycles 950. At a sixth portion of execution 945, code section 4 and 3 are executed sequentially at sites 1 and 3 respectively, which requires two (2) HW Op cycles 950. However, execution of common milestone pace code section a3 925 at site 2 is delayed until execution of the same common milestone pace code section a3 is also reached at sites 1 and 3 in the eight portion of execution 945. In the meantime, at a seventh portion of execution 945, code section 4 at site 3 is executed, which requires one (1) HW Op cycle 950. At the eighth portion, common milestone pace code section a3 is reached at sites 1, 2 and 3, and therefore the delayed execution at sites 1 and 2 are initiated in parallel with site 3 at the same time during the eighth portion of execution, which requires one (1) HW Op cycle 950. At a ninth portion of code execution, code sections 5 and 6 can be executed at sites 1 and 3 sequentially, which requires two (2) HW Op cycles 950. However, common milestone pace code section a4 935 at site 2 is delayed to force synchronized execution in parallel with code section a4 at sites 1 and 3 in the eleventh portion of execution. At a tenth portion, code section 6 930 can be executed at sites 1 and 3 together in parallel, which requires one (1) HW Op cycle 950. At the eleventh portion of execution, code section a4 935 can be synchronously executed at sites 1, 2 and 3 in parallel, which requires one (1) HW Op cycle 950.

As illustrated in FIG. 9, the given measurement for the given common milestone pace can advantageously be performed at the same time at all of the sites, e.g., in parallel to all DUTs. Furthermore, for non-common code sections, corresponding measurements can be performed at the same time (e.g., lucky synch) 945 when the given code segment 910 is performed at two or more of the same site, and therefore consume one HW Op. Measurements in non-common code sections can be referred to as lucky synchronization occurrences 945, because the given code segment 910 occur at two or more of the sites at the same time without the need to delay execution to get them to occur at the same time and there are no other measurement to be made at other sites at the given time. Another example of a lucky synch is the execution of code sections 6 at sites 1 and 3 during the 10^{th} section of time, which therefore consumes 1 HW Op. However, corresponding measurements of different code sections (e.g., 3, 2 and 4 at 5^{th} HW Op, 4 and 3 at 6^{th} HW Op, and 4 at 7^{th} HW Op) 950 are generally performed in series.

By synchronizing parallel execution on the common milestone paces 905, 915, 925, 935, the hardware operations 950 needed to perform the respective measurements, in the example, can advantageously be performed in 15 hardware operations 955, as compared to the 22 hardware operations 840 needed when the common milestone paces are not synchronized. Execution of the multi-site DUT test program with synchronized execution of milestone paces can be performed during production testing the DUTs.

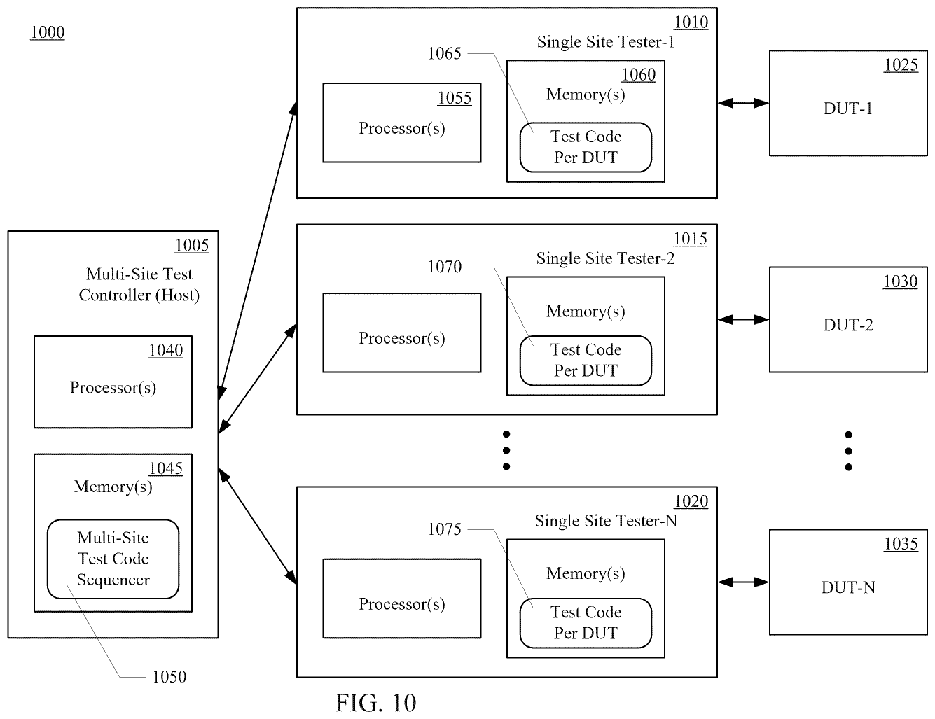

Referring now to FIG. 10, a test environment 1000, in accordance with aspects of the present technology, is shown. The test environment can include a multi-site test controller (e.g., host) 1005 and a plurality of single-site testers 1010-1020. Each single-site tester 1010-1020 can test a corresponding DUT 1025-1035. The multi-site test controller 1005 can be a Java software platform SmarTest8 test program executing on a Linux workstation, as one example. Each single-site tester 1010-1020 can be a computing device, such as a Mac Mini personal computer. The multi-site test controller 1005 can include one or more processors 1040 and one or more memories 1045, wherein the one or more processors 1040 are configured to execute a multi-site test code sequencer program 1050 stored in the one or more memories to perform the method of converting a single-site DUT test program to a multi-site DUT test program and sequencing execution of a plurality of single-site DUT test programs as described herein. Each single-site tester 1010-1020 can include one or more processors 1055 and one or more memories 1060, wherein the one or more processors 1055 are configured to execute a single-site test code 1065.

The single-site test code 1065 can be a single-site test program written in a script language such as Python, as one example. The multi-site test code sequencer 1050 controls the execution of the plurality of instances of the single-site test code 1065-1075 to synchronize execution of common milestone paces at the plurality of test sites. The multi-site test code sequencer 1050 is a test suite that is a high-level task scheduler. For a given DUT function, the single-site test code 1065-1075 is called by the multi-site test code sequencer 1050 to initiate testing to perform a plurality of measurements for testing the given function of the respective DUTs 1025-1035.

Referring now to Table 1, an example setup in SmarTest8, in accordance with aspects of the present technology, is shown.

List<PyTask>pytasks=IntStream.range (θ, clients.size( ) )
.mapToObj(idx->clients.get(idx).pyCmd_newTask(
   Arrays.asList(“.*”), // expected requests
   “task3_lcs”, // func name
   null, // args
   Map.of(“trajectory”, paces_for_test.get(idx)) // kwargs
)
). toList ( );
   PyTaskGroup grpl=new PyTaskGroup (pytasks);
   // check if pace info is ready, if not, start learning mode.
   List<String>milestone_paces=TaskMilestonePacesDB.getTaskMilestonePaces(“task3”);
   if(milestone_paces !=null) {
grpl.setPaceOderlnfo(milestone_paces); // pace order is enabled when pace info is set.
   }
   else {
grpl.enablePaceLearning(true);
   }

### Table 1

The initial statements inform proxy code of each site to create tasks. The ‘PyTaskGroup’ instruction manages the pace synchronization of tasks of sites. The ‘grpl.enablePaceLearning’ instruction enables pace order information learning mode.

Referring now to Table 2, an example SmarTest8 execution, in accordance with aspects of the present technology, is shown.

/for the first execution, pace info is learned and stored.
/for the following execution, pace info is used.
while (grpl.wait_for_pace_of_all_tasks( ) ) {
Summary s=grpl.summary ( );
System.out.printIn(s);
PaceGroup pg=s.waiting.get(e);
System.out.printIn(“process <”+pg.order+”<”+pg.paces);
for(Map.Entry<String, List<PyTask>>e: pg.actions.entrySet( ) ) {
   System.out.printIn(“\tdeal with req:”+e.gatKey( ));
   e.getValue( ).forEach(t ->{
      System.out.printIn(“treply to task<”+t.task_id( )+”>”);
      t.respond_to_py(nall);
   });
}
   }
   If(grpl.isPaceLearninEnabled( ) ) {
TaskMilestonePaceDB.setTaskMilestonePaces(“task3”, grpl.getPaceOrderlnfo( ));
System.out.printIn(“______ Milestone Paces Learned ______”);
grpl.printLearningResult(false);
   }
   System.out.printIn(“— — — — — — — — — — done”+i+“— — — — — — — — — — —”);

### Table 2

The while state waits for all sites' measurement requests. The Summary statement determined which site runs ahead and which runs behind. The ‘PaceGroup’ instruction summarizes them to groups. The same measurement is done simultaneously for the ‘System.out.printIn’ instruction of the ‘for’ statement. The ‘if’ statement determine is milestone learning is turned on.

Referring now to Table 3,

import os,sys
import asyncio
sys.path.append(os.path.dirname(______file______)) # add scr/demo folder to PYTHONPATH
from demo.tasks.task1 import main as task1
from demo.tasks.task2 import main as task2
from demo.tasks.task3_lcs import main as task3_lcs
async def new_task(call_smt, func_name, *args, **kwargs):
″ ″ ″
create a new task
″ ″ ″
if func_name==‘task1’
   return wait task1(*args, ** kwargs, call_smt=call_smt)
if func_name==‘task2’:
   return wait task2(*args, ** kwargs, call_smt=call_smt)
if func name==‘task3_lcs’:
   return wait task3_lcs(*args, ** kwargs, call_smt=call_smt)
raise ValueError(f ‘unkown func_name {func_name}’)

### Table 3

Referring now to Table 4

async def main(args, call_smt)
#step1
# do some DUT register setup
if args.bench: #bench is connected
   bench_result=await call_bench(“gpib command A”)
if call_smt:
   smt8_result=await call_smt(“Bluetooth/task1/step1”, “gpib command A”)
if args.bench and call_smt:
   cross_validate(bench_result, smt8_result)
# step 2
# . . . . . .
# step n
# . . . . . .

### Table 4

Referring now to Table 5 a log text of executions in pace learning and pace order modes, in accordance with aspects of the present technology, is shown. In the example there are four DUTs being tested that generate the following measurement trajectories separately:
Site1: 0, 1, 2, 3, 4, 5, 6, 7, 8, 9
Site2: 1, 2, 3, 4, 8, 9, 4, 5, 6, 7, 7, 7, 8
Site 3: 2, 3, 4, 5, 1, 2, 3, 4, 5, 6, 7, 8
Site4: 5, 6, 7, 8, 9, 5, 6, 7, 8, 1, 2

### Table 5

The milestone paces learned in accordance with the example will be: [5,6,7,8].

Referring now to Table 6, an exemplary log in pace learning mode, initially without any pace knowledge, in accordance with aspects of the present technology, is shown.

______ wait 0______
summary={
waiting:{
   <0>[task3/@0, task3/@1, task3/@2, task3/@5]: {meas_op:act0<={1@s1}, meas_op:act1 <={2@s2}, meas_op:act2<={3@s3}, meas_op:act5<={4@s4}}
}
   }
   process <0>[task3/@5, task3/@0, task3/@2, task3/@1]
deal with req:meas_op:act0
reply to task<1>
deal with req:meas_op:act1
reply to task<2>
deal with req:meas_op:act2
reply to task<3>
deal with req:meas_op:act5
reply to task<4>
   ______ wait 1______
   summary={
waiting:{
   <0>[task3/@1, task3/@2, task3/@3, task3/@6]: {meas_op:act1 <={1@s1}, meas_op:act2<={2@s2}, meas_op:act3<={3@s3}, meas_op:act6<={4@s4}}
}
   }
   process <0>[task3/@3, task3/@6, task3/@2, task3/@1]
deal with req:meas_op:act1
reply to task<1>
deal with req:meas_op:act2
reply to task<2>
deal with req:meas_op:act3
reply to task<3>
deal with req:meas_op:act6
reply to task<4>
   ______ wait 2______
   summary={
waiting:{
   <0>[task3/@2, task3/@3, task3/@4, task3/@7]: {meas_op:act2<={1@s1}, meas_op:act3<={2@s2}, meas_op:act4<={3@s3}, meas_op:act7<={4@s4}}
}
   }
   process <0>[task3/@7, task3/@4, task3/@3, task3/@2]
deal with req:meas_op:act2
reply to task<1>
deal with req:meas_op:act3
reply to task<2>
deal with req:meas_op:act4
reply to task<3>
deal with req:meas_op:act7
reply to task<4>
   ______ wait 3______
   summary={
waiting:{
   <0>[task3/@3, task3/@4, task3/@5, task3/@8]: {meas_op:act3<={1@s1}, meas_op:act4<={2@s2}, meas_op:act5<={3@s3}, meas_op:act8<={4@s4}}
}
   }
   process <0>[task3/@8, task3/@4, task3/@3, task3/@5]
deal with req:meas_op:act3
reply to task<1>
deal with req:meas_op:act4
reply to task<2>
deal with req:meas_op:act5
reply to task<3>
deal with req:meas_op:act8
reply to task<4>
   wait 4
   summary={
waiting:{
   <0>[task3/@1, task3/@4, task3/@8, task3/@9]: {meas_op:act1 <={3@s3}, meas_op:act4<={1@s1}, meas_op:act8<={2@s2}, meas_op:act9<={4@s4}}
}
   }
   process <0>[task3/@8, task3/@9, task3/@4, task3/@1]
deal with req:meas_op:act4
reply to task<1>
deal with req:meas_op:act8
reply to task<2>
deal with req:meas_op:act1
reply to task<3>
deal with req:meas_op:act9
reply to task<4>
   ______ wait 5______
   summary={
waiting:{
   <0>[task3/@2, task3/@5, task3/@9]: {meas_op:act2<={3@s3}, meas_op:act5<={1@s1, 4@s4}, meas_op:act9<={2@s2}}
}
   }
   process <0>[task3/@9, task3/@5, task3/@2]
deal with req:meas_op:act5
reply to task<1>
reply to task<4>
deal with req:meas_op:act9
reply to task<2>
deal with req:meas_op:act2
reply to task<3>
   ______ wait 6______
   summary={
waiting:{
   <0>[task3/@3, task3/@4, task3/@6]: {meas_op:act3<={3@s3}, meas_op:act4<={2@s2}, meas_op:act6<={1@s1, 4@s4}}
}
   }
   process <0>[task3/@4, task3/@3, task3/@6]
deal with req:meas_op:act6
reply to task<1>
reply to task<4>
deal with req:meas_op:act4
reply to task<2>
deal with req:meas_op:act3
reply to task<3>
   ______ wait 7______
   summary={
waiting:{
   <0>[task3/@4, task3/@5, task3/@7]: {meas_op:act4<={3@s3}, meas_op:act5<={2@s2}, meas_op:act7<={1@s1, 4@s4}}
}
   }
   process <0>[task3/@7, task3/@4, task3/@5]
deal with req:meas_op:act7
reply to task<1>
reply to task<4>
deal with req:meas_op:act5
reply to task<2>
deal with req:meas_op:act4
reply to task<3>
   ______ wait 8______
   summary={
waiting:{
   <0>[task3/@5, task3/@6, task3/@8]: {meas_op:act5<={3@s3}, meas_op:act6<={2@s2}, meas_op:act8<={1@s1, 4@s4}}
}
   }
   process <0>[task3/@8, task3/@6, task3/@5]
deal with req:meas_op:act8
reply to task<1>
reply to task<4>
deal with req:meas_op:act6
reply to task<2>
deal with req:meas_op:act5
reply to task<3>
   ______ wait 9______
   summary={
waiting:{
   <0>[task3/@1, task3/@6, task3/@7, task3/@9]: {meas_op:act1 <={4@s4}, meas_op:act6<={3@s3}, meas_op:act7<={2@s2}, meas_op:act9<={1@s1}}
}
   }
   process <0>[task3/@7, task3/@9, task3/@6, task3/@1]
deal with req:meas_op:act9
reply to task<1>
deal with req:meas_op:act7
reply to task<2>
deal with req:meas_op:act6
reply to task<3>
deal with req:meas_op:act1
reply to task<4>
   task<1> done successfully, result:
   ______ wait 10______
   summary={
done:[{1@s1}]
waiting:{
   <0>[task3/@2, task3/@7]: {meas_op:act2<={4@s4}, meas_op:act7<={2@s2, 3@s3}}
}
   }
   process <0>[task3/@7, task3/@2]
deal with req:meas_op:act7
reply to task<2>
reply to task<3>
deal with req:meas_op:act2
reply to task<4>
   task<4> done successfully, result:
   ______ wait 11______
   summary={
done:[{1@s1, 4@s4}]
waiting:{
   <0>[task3/@7, task3/@8]: {meas_op:act7<={2@s2}, meas_op:act8<={3@s3}}
}
   }
   process <0>[task3/@8, task3/@7]
deal with req:meas_op:act7
reply to task<2>
deal with req:meas_op:act8
reply to task<3>
   task<3> done successfully, result:
   ______ wait 12______
   summary={
done:[{1@s1, 3@s3, 4@s4}]
waiting:{
   <0>[task3/@8]: {meas_op:act8<={2@s2}}
}
   }
   process <0>[task3/@8]
deal with req:meas_op:act8
reply to task<2>
   task<2> done successfully, result:

### ______ Milestone Paces Learned______

Pace LCS:[task3/@5, task3/@6, task3/@7, task3/@8]
task<1>{
site:1
state:DONE_SUCCESS
result:
   }: task3/@0, task3/@1, task3/@2, task3/@3, task3/@4, \hat{ }task3/@5, \hat{ }task3/@6, \hat{ }task3/@7, \hat{ }task3/@8, task3/@9
   task<2>{
site:2
state:DONE_SUCCESS
result:
   }: task3/@1, task3/@2, task3/@3, task3/@4, task3/@8, task3/@9, task3/@4, \hat{ }task3/@5, \hat{ }task3/@6, \hat{ }task3/@7, \hat{ }task3/@8
   task<3>{
site:3
state:DONE_SUCCESS
result:
   }: task3/@2, task3/@3, task3/@4, task3/@5, task3/@1, task3/@2, task3/@3, task3/@4, task3/@5, \hat{ }task3/@6, \hat{ }task3/@7, \hat{ }task3/@8
   task<4>{
site:4
state:DONE_SUCCESS
result:
   }: \hat{ }task3/@5, \hat{ }task3/@6, \hat{ }task3/@7, \hat{ }task3/@8, task3/@9, task3/@5, task3/@6, task3/@7, task3/@8, task3/@1, task3/@2

### Table 6

Referring now to Table 7, an exemplary log in pace order mode, after learning, in accordance with aspects of the present technology, is shown.

______ wait 0______
summary={
waiting:{
   <0>[task3/@0, task3/@1, task3/@2]: {meas_op:act0<={1@s1}, meas_op:act1 <={2@s2}, meas_op:act2<={3@s3}};
   <1>[task3/@5]: {meas_op:act5<={4@s4}}
}
   }
   process <0>[task3/@0, task3/@2, task3/@1]
deal with req:meas_op:act0
reply to task<1>
deal with req:meas_op:act1
reply to task<2>
deal with req:meas_op:act2
reply to task<3>
   ______ wait 1______
   summary={
waiting:{
   <0>[task3/@1, task3/@2, task3/@3]: {meas_op:act1 <={1@s1}, meas_op:act2<={2@s2}, meas_op:act3<={3@s3}};
   <1>[task3/@5]: {meas_op:act5<={4@s4}}
}
   }
   process <0>[task3/@3, task3/@2, task3/@1]
deal with req:meas_op:act1
reply to task<1>
deal with req:meas_op:act2
reply to task<2>
deal with req:meas_op:act3
reply to task<3>
   ______ wait 2______
   summary={
waiting:{
   <0>[task3/@2, task3/@3, task3/@4]: {meas_op:act2<={1@s1}, meas_op:act3<={2@s2}, meas_op:act4<={3@s3}};
   <1>[task3/@5]: {meas_op:act5<={4@s4}}
}
   }
   process <0>[task3/@4, task3/@3, task3/@2]
deal with req:meas_op:act2
reply to task<1>
deal with req:meas_op:act3
reply to task<2>
deal with req:meas_op:act4
reply to task<3>
   ______ wait 3______
   summary={
waiting:{
   <0>[task3/@3, task3/@4]: {meas_op:act3<={1@s1}, meas_op:act4<={2@s2}};
   <1>[task3/@5]: {meas_op:act5<={3@s3, 4@s4}}
}
   }
   process <0>[task3/@4, task3/@3]
deal with req:meas_op:act3
reply to task<1>
deal with req:meas_op:act4
reply to task<2>
   ______ wait 4______
   summary={
waiting:{
   <0>[task3/@4, task3/@8]: {meas_op:act4<={1@s1}, meas_op:act8<={2@s2}};
   <1>[task3/@5]: {meas_op:act5<={3@s3, 4@s4}}
}
   }
   process <0>[task3/@8, task3/@4]
deal with req:meas_op:act4
reply to task<1>
deal with req:meas_op:act8
reply to task<2>
   ______ wait 5______
   summary={
waiting:{
   <0>[task3/@9]: {meas_op:act9<={2@s2}};
   <1>[task3/@5]: {meas_op:act5<={1@s1, 3@s3, 4@s4}}
}
   }
   process <0>[task3/@9]
deal with req:meas_op:act9
reply to task<2>
   ______ wait 6______
   summary={
waiting:{
   <0>[task3/@4]: {meas_op:act4<={2@s2}};
   <1>[task3/@5]: {meas_op:act5<={1@s1, 3@s3, 4@s4}}
}
   }
   process <0>[task3/@4]
deal with req:meas_op:act4
reply to task<2>
   ______ wait 7______
   summary={
waiting:{
   <1>[task3/@5]: {meas_op:act5<={1@s1, 2@s2, 3@s3, 4@s4}}
}
   }
   process <1>[task3/@5]
deal with req:meas_op:act5
reply to task<1>
reply to task<2>
reply to task<3>
reply to task<4>
   ______ wait 8______
   summary={
waiting:{
   <1>[task3/@1]: {meas_op:act1 <={3@s3}};
   <2>[task3/@6]: {meas_op:act6<={1@s1, 2@s2, 4@s4}}
}
   }
   process <1>[task3/@1]
deal with req:meas_op:act1
reply to task<3>
   ______ wait 9______
   summary={
waiting:{
   <1>[task3/@2]: {meas_op:act2<={3@s3}};
   <2>[task3/@6]: {meas_op:act6<={1@s1, 2@s2, 4@s4}}
}
   }
   process <1>[task3/@2]
deal with req:meas_op:act2
reply to task<3>
   ______ wait 10______
   summary={
waiting:{
   <1>[task3/@3]: {meas_op:act3<={3@s3}};
   <2>[task3/@6]: {meas_op:act6<={1@s1, 2@s2, 4@s4}}
}
   }
   process <1>[task3/@3]
deal with req:meas_op:act3
reply to task<3>
   ______ wait 11______
   summary={
waiting:{
   <1>[task3/@4]: {meas_op:act4<={3@s3}};
   <2>[task3/@6]: {meas_op:act6<={1@s1, 2@s2, 4@s4}}
}
   }
   process <1>[task3/@4]
deal with req:meas_op:act4
reply to task<3>
   ______ wait 12______
   summary={
waiting:{
   <1>[task3/@5]: {meas_op:act5<={3@s3}};
   <2>[task3/@6]: {meas_op:act6<={1@s1, 2@s2, 4@s4}}
}
   }
   process <1>[task3/@5]
deal with req:meas_op:act5
reply to task<3>
   ______ wait 13______
   summary={
waiting:{
   <2>[task3/@6]: {meas_op:act6<={1@s1, 2@s2, 3@s3, 4@s4}}
}
   }
   process <2>[task3/@6]
deal with req:meas_op:act6
reply to task<1>
reply to task<2>
reply to task<3>
reply to task<4>
   ______ wait 14______
   summary={
waiting:{
   <3>[task3/@7]: {meas_op:act7<={1@s1, 2@s2, 3@s3, 4@s4}}
}
   }
   process <3>[task3/@7]
deal with req:meas_op:act7
reply to task<1>
reply to task<2>
reply to task<3>
reply to task<4>
   ______ wait 15______
   summary={
waiting:{
   <3>[task3/@7]: {meas_op:act7<={2@s2}};
   <4>[task3/@8]: {meas_op:act8<={1@s1, 3@s3, 4@s4}}
}
   }
   process <3>[task3/@7]
deal with req:meas_op:act7
reply to task<2>
   ______ wait 16______
   summary={
waiting:{
   <3>[task3/@7]: {meas_op:act7<={2@s2}};
   <4>[task3/@8]: {meas_op:act8<={1@s1, 3@s3, 4@s4}}
}
   }
   process <3>[task3/@7]
deal with req:meas_op:act7
reply to task<2>
   ______ wait 17______
   summary={
waiting:{
   <4>[task3/@8]: {meas_op:act8<={1@s1, 2@s2, 3@s3, 4@s4}}
}
   }
   process <4>[task3/@8]
deal with req:meas_op:act8
reply to task<1>
reply to task<2>
reply to task<3>
reply to task<4>
   task<2> done successfully, result:
task<3> done successfully, result:
   ______ wait 18______
   summary={
done:[{2@s2, 3@s3}]
waiting:{
   <4>[task3/@9]: {meas_op:act9<={1@s1, 4@s4}}
}
   }
   process <4>[task3/@9]
deal with req:meas_op:act9
reply to task<1>
reply to task<4>
   task<1> done successfully, result:
   ______ wait 19______
   summary={
done:[{1@s1, 2@s2, 3@s3}]
waiting:{
   <4>[task3/@5]: {meas_op:act5<={4@s4}}
}
   }
   process <4>[task3/@5]
deal with req:meas_op:act5
reply to task<4>
   ______ wait 20______
   summary={
done:[{1@s1, 2@s2, 3@s3}]
waiting:{
   <4>[task3/@6]: {meas_op:act6<={4@s4}}
}
   }
   process <4>[task3/@6]
deal with req:meas_op:act6
reply to task<4>
   ______ wait 21______
   summary={
done:[{1@s1, 2@s2, 3@s3}]
waiting:{
   <4>[task3/@7]: {meas_op:act7<={4@s4}}
}
   }
   process <4>[task3/@7]
deal with req:meas_op:act7
reply to task<4>
   ______ wait 22______
   summary={
done:[{1@s1, 2@s2, 3@s3}]
waiting:{
   <4>[task3/@8]: {meas_op:act8<={4@s4}}
}
   }
   process <4>[task3/@8]
deal with req:meas_op:act8
reply to task<4>
   ______ wait 23______
   summary={
done:[{1@s1, 2@s2, 3@s3}]
waiting:{
   <4>[task3/@1]: {meas_op:act1 <={4@s4}}
}
   }
   process <4>[task3/@1]
deal with req:meas_op:act1
reply to task<4>
   ______ wait 24______
   summary={
done:[{1@s1, 2@s2, 3@s3}]
waiting:{
   <4>[task3/@2]: {meas_op:act2<={4@s4}}
}
   }
   process <4>[task3/@2]
deal with req:meas_op:act2
reply to task<4>
   task<4> done successfully, result:

### Table 7

Referring now to Tables 8 and 9, an exemplary explanation of reading a log text, in accordance with aspects of the present technology is shown. Table 8 shows trajectories of four DUTs, and paces for each site at a moment of wait 4.
Site1: [0, 1, 2, 3, 4, 5, 6, 7, 8, 9] Site1 is at pace 4
Site2: [1, 2, 3, 4, 8, 9, 4, 5, 6, 7, 7, 7, 8] Site2 is at pace 8
Site3: [2, 3, 4, 5, 1, 2, 3, 4, 5, 6, 7, 8] Site3 is at pace 5
Site4: [5, 6, 7, 8, 9, 5, 6, 7, 8, 1, 2] Site4 is at pace 5 (the first)

### Table 8

The highlighting indicated the current pace cat each site. The underlining shows where the current or next pace 5 is. Table 9 shows a snippet of the log in pace order mode after learning.

______ wait 4______
summary={
waiting:{
   <0>[task3/@4, task3/@8]: {meas_op:act4<={1@s1}, meas_op:act8<={2@s2}};
   <1>[task3/@5]: {meas_op:act5<={3@s3, 4@s4}}
}
   }
   process <0>[task3/@8, task3/@4]
deal with req:meas_op:act4
reply to task<1>
deal with req:meas_op:act8
reply to task<2>

### Table 9

The highlighting indicates the respective current pace of the respective site. Group0 holds the slowest sites: s1 and s2, because 5 is the first milestone, s3, s4 are faster than s1 and s2. Group1 holds the fastest sites: s3 and s4. In act4 wait, the hardware services s1 and s2, to make them advance to catch up with s3 and s4. s3 and s4 are just waiting.

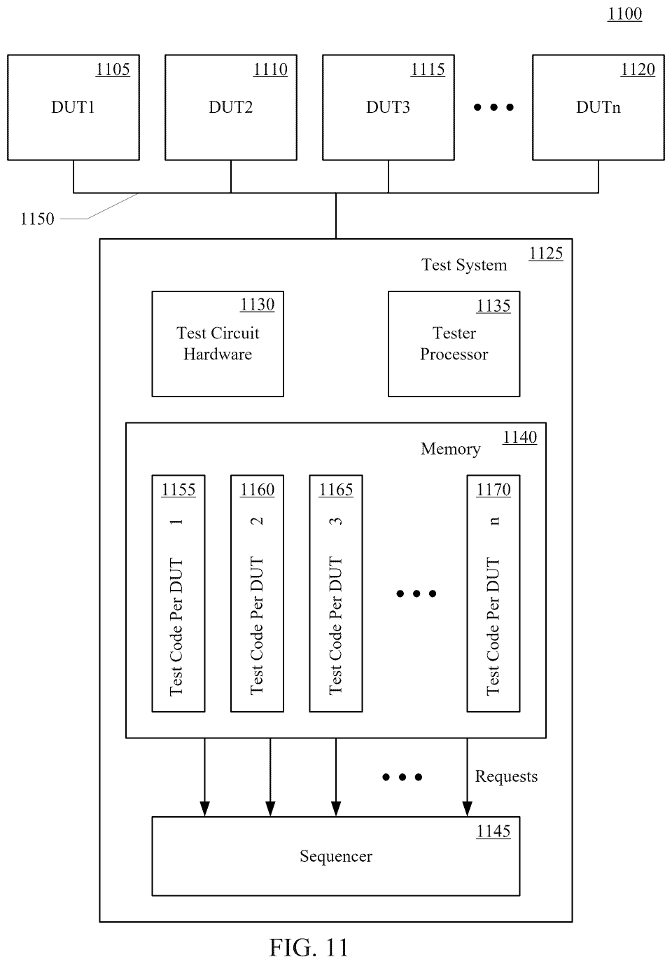

Referring now to FIG. 11, a test environment, in accordance with aspects of the present technology, is shown. The test environment can include a plurality of DUTs 1105-1120 and a test system 1125 including test system hardware. The test system hardware can include test circuit hardware 1130, one or more tester processor 1135, one or more memories 1140, and a sequencer 1145. The test system hardware can be coupled to the plurality of DUTs by one or more communication interfaces 1150. A method of testing includes generating a plurality of instances of a test program 1155-1170, the plurality of instances causing the test system hardware to test the plurality of DUTs 1105-1120, wherein each instance is associated with a respective DUT of the plurality of DUTs. The testing method further includes identifying first code segments, of the plurality of instances, that comprise one of: a loop with a conditional loop count and an IF statement, and identifying second code segments that are free of a loop with a conditional count and further free of an IF statement. The testing method also includes receiving, at said multi-site test system, requests to execute code segments from said plurality of instances and executing received requested code segments by applying tests to said plurality of DUTs based thereon and executing received requested code segments by applying tests to the plurality of DUTs based thereon. Executing the received request code segments can include synchronizing execution of requested second code segments of a same code identifier, wherein measurements associated with said synchronizing are aligned.

Executing can further include executing requested first code segments of differing functions in sequence on DUTs of the plurality of DUTs. Executing can also further include executing requested first code segments of a same function in parallel on DUTs of the plurality of DUTs. The test system can be a multi-site test system. The plurality of instances are based on a test program of a script language written for single-site testing. Analyzing the plurality of instances to determine first code segments and second code segments can include analyzing the plurality of instances to determine code segments of a same function. Delaying execution of one or more requested second code segments of a same function and the executing the requested second segments of the same function on all of the plurality of DUTs in parallel, in combination, operate to synchronize execution of the second code segments of the plurality of instances.

Executing the code segments can further include executing requested first code segments when the first code segments are requested, and synchronizing, for parallel execution, requested second code segments of a same function. Executing requested first code segments when the first code segments are requested can include executing requested first code segments of differing functions in sequence on DUTs of the plurality of DUTs, and executing requested first code segments of a same function in parallel on DUTs of the plurality of DUTs. Analyzing the plurality of instances to determine first code segments and second code segments can comprise analyzing the plurality of instances to determine code segments of a same function.

Multi-site test programs, such as SmarTest8 require measurements to be done simultaneously on sites. Therefore, by synchronizing on common milestone paces, aspects of the present technology advantageously shorten multi-site testing time. Aspects of the present application also advantageously shorten multi-site testing time while keeping the test routines of the single-site DUT test program as much as possible, so that any future changes of the single-site DUT test program can be easily merged into the multi-site DUT test program.

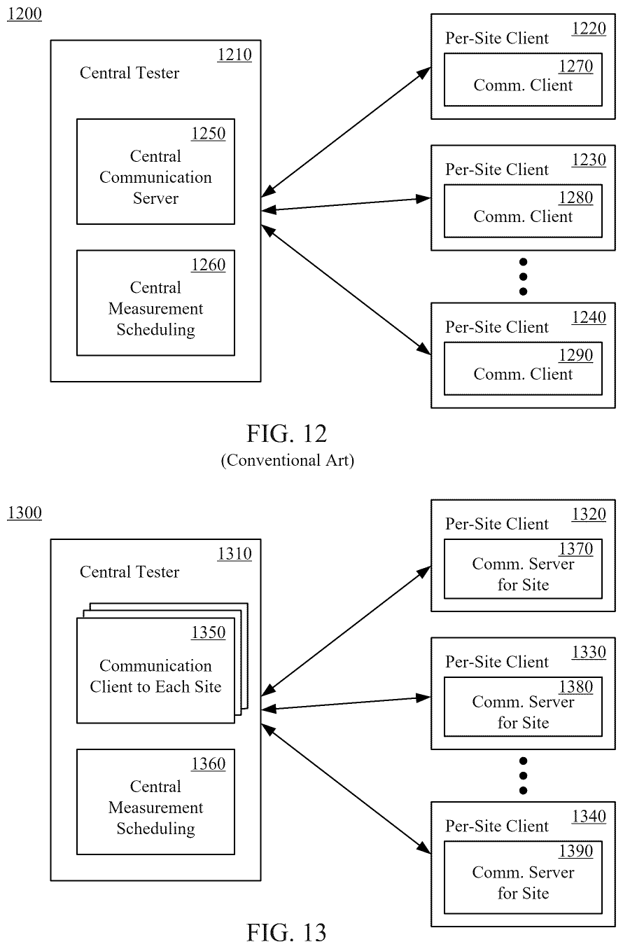

Referring now to FIG. 12, a centralized multi-site test system according to the conventional art is shown. The centralized multi-site test system 1200 can include a central tester 1210 and a plurality of per-site clients 1220-1240. The central tester 1210 can include a central communication server 1250 and a central measurement scheduling unit 1260. The central measurement scheduling unit 1260 can manage DUT measurements by the per-site clients 1220-1240. Each per-site client 1220-1240 can include a communication client 1270-1290. The central communication server 1250 of the central tester 1210 and the communication clients 1270-1290 of the per-site clients 1220-1240 can manage communications between the central tester 1210 and the per-site clients 1220-1240.

Referring now to FIG. 13, a decentralized multi-site test system, in accordance with aspects of the present technology. The decentralized multi-site test system 1300 can include a central tester 1310 and a plurality of per-site clients 1320-1340. The central tester 1310 can include a communication client for each site 1350 and a central measurement scheduling unit 1360. The central measurement scheduling unit 1360 can manage DUT measurements by the per-site clients 1320-1340. Each per-site client 1320-1340 can include a communication server for the respective site 1370-1390. The communication clients 1350 of the central tester 1210 and the communication servers 1370-1390 of the per-site clients 1320-1340 can manage communications between the central tester 1310 and the per-site clients 1320-1340. The centralized communication server of the conventional art, however, makes programming the central tester 1210 relatively more limited. In contrast, the decentralized communication clients for each site enables increased programming flexibility of the central tester 1310.

The following clauses pertain to aspects of the present technology and point out features, elements, or steps that may be used or otherwise combined in achieving any number of embodiments of the present technology.

Aspect 1 includes a test environment comprising a plurality of devices under test (DUTs) and a multi-site test system including a test system hardware, a method of testing comprising: generating a plurality of instances of a test program within a plurality of single-site systems, said plurality of instances causing said test system hardware to test said plurality of DUTs, wherein each instance is associated with a respective single-site system of said plurality of single-site systems and further associated with a respective DUT of said plurality of DUTs; of the plurality of instances, identifying first code segments that comprise one of: a loop with a conditional loop count and an IF statement, and identifying second code segments that are free of a loop with a conditional count and further free of an IF statement; receiving, at said multi-site test system, requests to execute code segments from said plurality of instances and executing received requested code segments by applying tests to said plurality of DUTs based thereon, wherein said executing comprises: synchronizing execution of requested second code segments of a same code identifier, wherein measurements associated with said synchronizing are aligned.

Aspect 2 includes the method as described in Aspect 1 wherein said executing further comprises executing in sequence requested first code segments of differing code identifiers that are requested together.

Aspect 3 includes the method as described in Aspect 2 wherein said executing further comprises synchronizing execution of requested first code segments of a same code identifier.

Aspect 4 includes the method as described in any one of Aspects 1-3 wherein said test system is a Smartest8 compatible system.

Aspect 5 includes the method as described in any one of Aspects 1-4 wherein said test program comprises a script language written for single-site testing.

Aspect 6 includes the method as described in any one of Aspects 1-5 wherein said identifying second code segments that are free of a loop with a conditional count and an IF statement comprises using code parameters of said second code segments.

Aspect 7 includes the method as described in any one of Aspects 1-6 wherein said measurements associated with said synchronizing are applied across said plurality of DUTs at a same time by said test system hardware.

Aspect 8 includes a test environment comprising a plurality of devices under test (DUTs) and a test system including a test system hardware, a method of testing said plurality of DUTs comprising: generating a plurality of instances of a single-site test program, said plurality of instances causing said test system hardware to test said plurality of DUTs, wherein each instance is associated with a respective DUT of said plurality of DUTs and operates on a respective single-site test system; of the plurality of instances, identifying first code segments that comprise one of: a loop of a conditional loop count and an IF statement, and further identifying second code segments that are free of a loop of a conditional count and an IF statement; receiving, at said test system, requests to execute code segments from said plurality of instances and executing received requested code segments by causing said test system hardware to apply tests to said plurality of DUTs based thereon, wherein said executing comprises: executing requested first code segments as said first code segments are requested; and synchronizing execution of requested second code segments of a same code identifier, wherein DUT measurements associated with said synchronizing are temporally aligned across said plurality of DUTs.

Aspect 9 includes the method as described in Aspect 8 wherein said executing requested first code segments as said first code segments are requested comprises: executing in sequence requested first code segments of differing code identifiers that are received together; and synchronizing execution of requested first code segments of a same code identifier that are received together.

Aspect 10 includes the method as described in any one of Aspects 8-9 wherein said test system is a multi-site test system.

Aspect 11 includes the method as described in Aspect 10 wherein said multi-site test system is compatible with a Smartest8 system.

Aspect 12 includes the method as described in any one of Aspects 8-11 wherein said single-site test program comprises a script language written for single-site testing.

Aspect 13 includes the method as described in any one of Aspects 8-13 wherein said identifying second code segments that are free of a loop of a conditional count and an IF statement comprises using code parameters associated with said second code segments.

Aspect 14 includes a test environment comprising a plurality of single-site test systems each operable run a single-site test program for a respective single device under test (DUT) and a multi-site test system including a test system hardware, a method of testing comprising: generating a plurality of instances of said single-site test program for said plurality of single-site test systems for testing a plurality of DUTs, wherein each single-site test system receives a respective instance of said plurality of instances; of the plurality of instances, identifying first code segments that comprise one of: a loop of a conditional loop count and an IF statement, and further identifying second code segments that are free of a loop of a conditional count and an IF statement; receiving requests, at said multi-site test system, to execute code segments from said plurality of instances and said multi-site test system executing received requested code segments by causing said test system hardware to apply tests to said plurality of DUTs based thereon, wherein said executing comprises: synchronizing execution of requested second code segments of a same code identifier wherein said test system hardware applies measurements associated with said synchronizing to said plurality of DUTs at a same time.

Aspect 15 includes the method as described in Aspect 14 wherein said executing further comprises executing in sequence first code segments of differing code identifiers that are requested together.

Aspect 16 includes the method as described in any one of Aspects 14-15 wherein said executing further comprises synchronizing execution of first code segments of a same code identifier that are requested together.

Aspect 17 includes the method as described in any one of Aspects 14-16 wherein said measurements associated with said synchronizing are temporally aligned.

Aspect 18 includes the method as described in any one of Aspects 14-17 wherein said identifying second code segments that are free of a loop of a conditional count and an IF statement is based on code parameters associated with said second code segments.

Aspect 19 includes the method as described in any one of Aspects 14-18 wherein said code parameters are associated with calls of said second code segments.

Aspect 20 includes the method as described in any one of Aspects 14-19 wherein said multi-site test system is compatible with a Smartest8 system.

Aspect 21 includes a method of testing device under test (DUTs) comprising: receiving a single-site DUT test program; determining a longest execution sequence of the DUT test program; determining common milestone paces based on the longest sequence of the DUT test program; and synchronizing execution of the common milestone paces for multi-site execution of the DUT test program.

Aspect 22 includes the method of testing the DUTs according to Aspect 21, wherein determining the longest execution sequence of the DUT test program and determining common milestone paces based on the longest sequence of the DUT test program are performed during a training phase.

Aspect 23 includes the method of testing the DUTs according to any one of Aspects 21-22, wherein synchronizing execution of the common milestone paces for multi-site execution of the DUT test program is performed during production testing of DUTs.

Aspect 24 includes the method of testing the DUTs according to any one of Aspects 21-23, wherein a given measurement of the multi-site execution of the DUT test program are performed at the same time period on a set of DUTs at a set of test sites.

Aspect 25 includes the method of testing the DUTs according to any one of Aspects 21-24, wherein different measurements performed at different sites performed at the same time period are performed sequentially within the same time period.

Aspect 26 includes the method of testing the DUTs according to any one of Aspects 21-25, wherein portions of code of the test program that are executed by all of the DUTs at various times in a given sequence comprise the common milestone paces.

In sum, the disclosed techniques overcome the limitations of traditional methods by advantageously converting systems for testing single or relatively small numbers of units to production test systems for testing a large number of units. Test systems typically developed for bench testing devices in the research and development phase can be readily converted to test systems for production testing. The techniques advantageously include pace synchronization of multiple instances of single-site DUT test programs. The techniques advantageously eliminate the need to totally rewrite the test routine for a multi-site test system of the conventional art. Alternatively, the techniques advantageously eliminate the need for a bridging solution between the single-site test to the multi-site test system of the conventional art. The techniques also advantageously shorten multi-site testing time while keeping the test routines of the single-site DUT test program as much as possible, so that any future changes of the single-site DUT test program can be easily merged into the multi-site DUT test program.

At least one technical advantage of the disclosed techniques is that a single-site test system can be converted to a single-site tester and a multi-site test controller. The multi-site test controller can be configured to control a plurality of instances of the single-site tester to test a plurality of DUTs. Control by the multi-site test controller includes pace synchronization of test measurements performed on a plurality of DUTs by respective instances of the single-site testers. The conversion of the single-site test system to a multi-site test system can include determining a longest execution sequence of a DUT test program, determining common milestone paces based on the longest sequence of the DUT test program, and synchronizing execution of the common milestone paces for multi-site execution of the DUT test program. The common milestone paces can be portions of code of the test program that are executed by all of the DUTs at various times in a given sequence. Synchronizing execution of common milestone processes by the plurality of single-site testers on respective DUTs advantageously reduces the number of hardware operations needed to perform the testing of the DUTs.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read— only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. While the preceding is directed to embodiments of the present disclosure, other and further embodiments of the disclosure may be devised without departing from the basic scope thereof, and the scope thereof is determined by the claims that follow.

The embodiments were chosen and described in order to best explain the principles of the present technology and its practical application, to thereby enable others skilled in the art to best utilize the present technology and various embodiments with various modifications as are suited to the particular use contemplated. It is intended that the scope of the invention be defined by the claims appended hereto and their equivalents.

1. In a test environment comprising a plurality of devices under test (DUTs) and a multi-site test system including a test system hardware, a method of testing comprising:
generating a plurality of instances of a test program within a plurality of single-site systems, said plurality of instances causing said test system hardware to test said plurality of DUTs, wherein each instance is associated with a respective single-site system of said plurality of single-site systems and further associated with a respective DUT of said plurality of DUTs;
of the plurality of instances, identifying first code segments that comprise one of: a loop with a conditional loop count and an IF statement, and identifying second code segments that are free of a loop with a conditional count and further free of an IF statement;
receiving, at said multi-site test system, requests to execute code segments from said plurality of instances and executing received requested code segments by applying tests to said plurality of DUTs based thereon, wherein said executing comprises:
synchronizing execution of requested second code segments of a same code identifier, wherein measurements associated with said synchronizing are aligned.

2. The method of claim 1 wherein said executing further comprises executing in sequence requested first code segments of differing code identifiers that are requested together.

3. The method of claim 2 wherein said executing further comprises synchronizing execution of requested first code segments of a same code identifier.

4. The method of claim 1 wherein said multi-site test system is a Smartest8 compatible system.

5. The method of claim 4 wherein said test program comprises a script language written for single-site testing.

6. The method of claim 3 wherein said identifying second code segments that are free of a loop with a conditional count and an IF statement comprises using code parameters of said second code segments.

7. The method of claim 1 wherein said measurements associated with said synchronizing are applied across said plurality of DUTs at a same time by said test system hardware.

8. In a test environment comprising a plurality of devices under test (DUTs) and a test system including a test system hardware, a method of testing said plurality of DUTs comprising:
generating a plurality of instances of a single-site test program, said plurality of instances causing said test system hardware to test said plurality of DUTs, wherein each instance is associated with a respective DUT of said plurality of DUTs and operates on a respective single-site test system;
of the plurality of instances, identifying first code segments that comprise one of: a loop of a conditional loop count and an IF statement, and further identifying second code segments that are free of a loop of a conditional count and an IF statement;
receiving, at said test system, requests to execute code segments from said plurality of instances and executing received requested code segments by causing said test system hardware to apply tests to said plurality of DUTs based thereon, wherein said executing comprises:
executing requested first code segments as said first code segments are requested; and
synchronizing execution of requested second code segments of a same code identifier, wherein DUT measurements associated with said synchronizing are temporally aligned across said plurality of DUTs.

9. The method of claim 8 wherein said executing requested first code segments as said first code segments are requested comprises:
executing in sequence requested first code segments of differing code identifiers that are received together; and
synchronizing execution of requested first code segments of a same code identifier that are received together.

10. The method of claim 8 wherein said test system is a multi-site test system.

11. The method of claim 10 wherein said multi-site test system is compatible with a Smartest8 system.

12. The method of claim 10 wherein said single-site test program comprises a script language written for single-site testing.

13. The method of claim 9 wherein said identifying second code segments that are free of a loop of a conditional count and an IF statement comprises using code parameters associated with said second code segments.

14. In a test environment comprising a plurality of single-site test systems each operable to run a single-site test program for a respective single device under test (DUT) and a multi-site test system including a test system hardware, a method of testing comprising:
generating a plurality of instances of said single-site test program for said plurality of single-site test systems for testing a plurality of DUTs, wherein each single-site test system receives a respective instance of said plurality of instances;
of the plurality of instances, identifying first code segments that comprise one of: a loop of a conditional loop count and an IF statement, and further identifying second code segments that are free of a loop of a conditional count and an IF statement;
receiving requests, at said multi-site test system, to execute code segments from said plurality of instances and said multi-site test system executing received requested code segments by causing said test system hardware to apply tests to said plurality of DUTs based thereon, wherein said executing comprises:
synchronizing execution of requested second code segments of a same code identifier wherein said test system hardware applies measurements associated with said synchronizing to said plurality of DUTs at a same time.

15. The method of claim 14 wherein said executing further comprises executing in sequence first code segments of differing code identifiers that are requested together.

16. The method of claim 15 wherein said executing further comprises synchronizing execution of first code segments of a same code identifier that are requested together.

17. The method of claim 14 wherein said measurements associated with said synchronizing are temporally aligned.

18. The method of claim 17 wherein said identifying second code segments that are free of a loop of a conditional count and an IF statement is based on code parameters associated with said second code segments.

19. The method of claim 18 wherein said code parameters are associated with calls of said second code segments.

20. The method of claim 14 wherein said multi-site test system is compatible with a Smartest8 system.
